(19) United States
(12) Patent Application Publication
(10) Pub. No.: US 2006/0250533 A1
(43) Pub. Date: Nov. 9, 2006

(54) Pixel structure with improved viewing angle

(76) Inventor: Po-Sheng Shih, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/119,773

(22) Filed: May 3, 2005

(51) Int. Cl. G02F 1/1343

(52) U.S. Cl. 349/38

(57) ABSTRACT

According to the present invention, a pixel region is divided into a plurality of sub-pixel regions. Each sub-pixel region has independent adjustable parameters related to its optical characteristic. In other words, different optical characteristic may be presented by adjusting the parameter of a sub-pixel region. The optical characteristic of the whole pixel region is a combination of each sub-pixel region optical characteristic. By adjusting the parameter related to optical characteristics in each sub-pixel region, an optimum combining optical characteristic may be presented.

### FIELD OF THE INVENTION

The present invention relates to a pixel structure, and more particularly to a pixel structure with improved viewing angles of a liquid crystal display.

### BACKGROUND OF THE INVENTION

Liquid crystal displays have been widely applied in electrical products, such as digital watches and calculators, for a long time. To provide a wider viewing range, Fujitsu commercialized a multi-domain vertically aligned liquid crystal display (MVA-LCD) in 1997, disclosed by A. Takeda, S. Kataoka, T. Sasaki, H. Chida, H. Tsuda, K Okamoto, Y. Koike, SID '98 Digest, 1077 (1998). MVA has almost perfect viewing angle characteristics. However, a notable weak point is that the skin color of Asian people (light orange or pink) appears bluish or whitish from an oblique viewing direction.

The transmittance-voltage (T-V) characteristic of MVA in the normal direction is shown by the solid line in FIG. 1. The transmittance changes monotonically as the applied voltage increases. However, in the oblique direction, it winds and the various gray scales become the same, changing the displayed color as shown by the dashed line in FIG. 1. A method, developed by H. Yoshida et al. (Fujitsu Display Technologies Corporation) and PL Chen et al. (AU Optronics Corporation), is provided to improve this foregoing problem. This method combines two different T-V characteristics. The dotted line in FIG. 2 shows the original T-V characteristics in the oblique direction. The thin solid line in FIG. 2 shows other T-V characteristics with a higher threshold voltage. By optimizing the threshold voltage and maximum transmittance of these two lines, monotonic characteristics can be realized, as shown by the bold solid line in FIG. 2.

According to the typical method, each pixel is divided into two areas. One area has the original threshold voltage and the other area has a higher one. FIG. 3 shows a cross-sectional view of a pixel region for realizing the typical method. FIG. 4 illustrates an equivalent circuit of FIG. 3.

Referring to FIGS. 3 and 4, a common electrode 304 is formed on a glass substrate 300. Sequences of protrusions 306 are formed over the common electrode 304. Scan lines 318 are arranged across data lines 320. TFTs 308 are arranged in the intersection points of the scan lines 318 and the data lines 320 on the glass substrate 302. An insulating layer 314, such as a SiN layer, is formed over the TFTs 308. Pixel electrodes 310, such as an ITO layer, are formed over the insulating layer 314. Slits 316 divide the Pixel electrodes 310 into pixel electrodes 310a and 310b. In other words, a pixel region is divided into two parts, region A and region B. The pixel electrode 310a in the region A is connected to the source electrodes of the TFT 308 through a via 312. The pixel electrode 310b in region B is in a floating state.

The insulating layer 314 produces a capacitor, C_{SIN}, between the pixel electrodes 310b and the source electrode of the TFT 308. One liquid crystal capacitor, C_{LC1}, exists between the common electrode 304 and the pixel electrode 310a. The other liquid crystal capacitor, C_{LC2}, exists between the common electrode 304 and the pixel electrode 310b. The main function of a storage capacitor C_{S} is to maintain the constancy of the voltage value applied to the liquid crystal capacitor C_{LC1} and C_{LC2.} That is, before the data stored in the liquid crystal capacitor C_{LC1} and C_{LC2} are refreshed, the voltage applied to the liquid crystal capacitor C_{LC1} and C_{LC2} is maintained by the storage capacitor C_{S}. However, due to the capacitor C_{SIN}, the potential difference V1 between the common electrode 304 and the source electrode of TFT 308 is divided into V2 and V3. In other words, the voltage to transform the liquid crystal molecule in region B is less than the voltage in region A. That is, a higher threshold voltage for transforming the liquid crystal molecule is required in region B. In the typical method, the original wind T-V characteristic may be improved by the T-V characteristic in region B.

However, there is a serious problem in the typical method. Because the pixel electrode 310b is in a floating state, the charge therein is not exhausted after the voltage applied to the pixel region is removed. In other words, the data stored in the liquid crystal capacitor C_{LC2} is not completely refreshed before this pixel region is scanned again. This causes a phenomenon where, when a voltage is applied, the liquid crystalline molecules in region B do not change to predetermined orientations due to the accumulated charges. Therefore, the optical characteristic is affected due to the accumulated charge in the liquid crystal capacitor C_{LC2}. This is an inherent problem in the typical structure.

### SUMMARY OF THE INVENTION

Therefore, it is the main object of the present invention to improve a viewing angle characteristic of a liquid crystal display.

Another purpose of the present invention is to realize a liquid crystal display exhibiting an adjustable T-V characteristic.

The further purpose of the present invention is to provide a pixel structure that provides two different T-V characteristics with no accumulated charge.

The further purpose of the present invention is to provide a LCD that has enhanced viewing angle characteristics.

According to the present invention, a pixel region is divided to a plurality of sub-pixel regions. Each sub-pixel region has independent adjustable parameters related to its optical characteristic. In other words, different optical characteristic may be presented by adjusting the parameter of a sub-pixel region. The optical characteristic of the whole pixel region combines each sub-pixel region optical characteristic. By adjusting the parameter related to optical characteristic in each sub-pixel region, an optimum combining optical characteristic is presented.

According to the present invention, a pixel region is divided into two sub-pixel regions. Each sub-pixel region includes a liquid crystal capacitor and a storage capacitor. These capacitors are connected to a thin film transistor. The gate electrode of the thin film transistor is connected with a scan line. The drain electrode of the thin film transistor is connected with a video data line. The capacitance of the storage capacitors is different, so each sub-pixel region has a different optical characteristic. By adjusting the capacitances of the storage capacitors, an optimum combination of optical characteristics may be presented.

According to the other aspect of the present invention, a pixel region is divided into two sub-pixel regions. Each sub-pixel region includes a thin film transistor, a liquid crystal capacitor and a storage capacitor. The capacitance of the diffuse capacitors of the thin film transistor is different, so each sub-pixel region has a different optical characteristic. By adjusting the capacitances of the diffuse capacitors, an optimum combination optical characteristic is presented.

According to another aspect of the present invention, a pixel region is divided into two sub-pixel regions. Each sub-pixel region includes a thin film transistor, a liquid crystal capacitor and a storage capacitor. The capacitance of the liquid crystal capacitors is different, so each sub-pixel region has a different optical characteristic. By adjusting the capacitances of the liquid crystal capacitors, an optimum combination optical characteristic is presented.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a transmittance-voltage (T-V) characteristic of MVA in the normal direction;

FIG. 2 illustrates the combination T-V characteristics in the oblique direction;

FIG. 3 illustrates a cross-sectional view of a convention pixel region;

FIG. 4 illustrates an equivalent circuit of FIG. 3;

FIG. 5A illustrates a schematic diagram of an equivalent circuit of a pixel region of a liquid crystal display in accordance with the first embodiment of the present invention;

FIG. 5B illustrates a cross-sectional view of a pixel region in accordance with the first embodiment of the present invention;

FIG. 5C illustrates a waveform fo operating the pixel region in accordance with the first embodiment of the present invention;

FIG. 6 illustrates a cross-sectional view of a pixel region in accordance with the second embodiment of the present invention;

FIG. 7 illustrates a cross-sectional view of a pixel region in accordance with the third embodiment of the present invention;

FIG. 8A illustrates a schematic diagram of an equivalent circuit of a pixel region of a liquid crystal display in accordance with the fourth embodiment of the present invention;

FIG. 8B illustrates a waveform fo operating the pixel region in accordance with the fourth embodiment of the present invention.

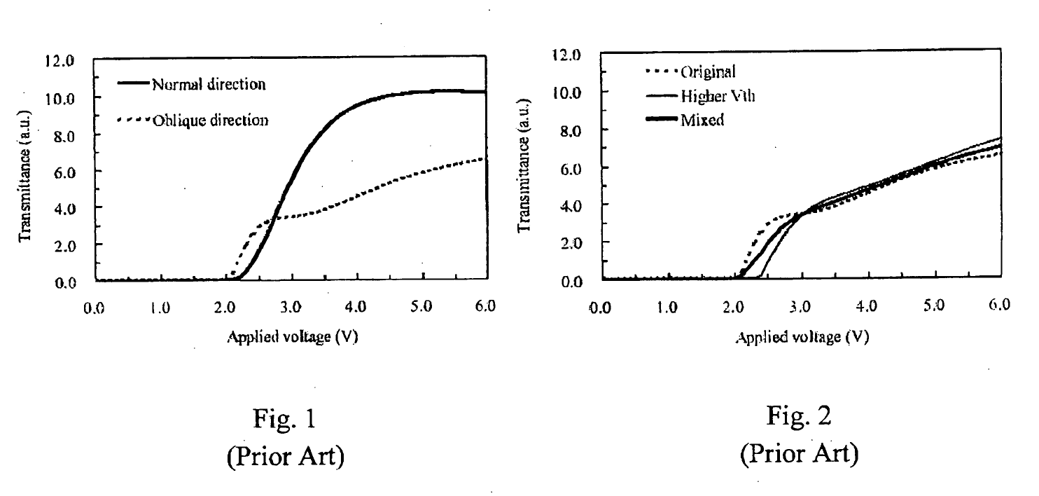

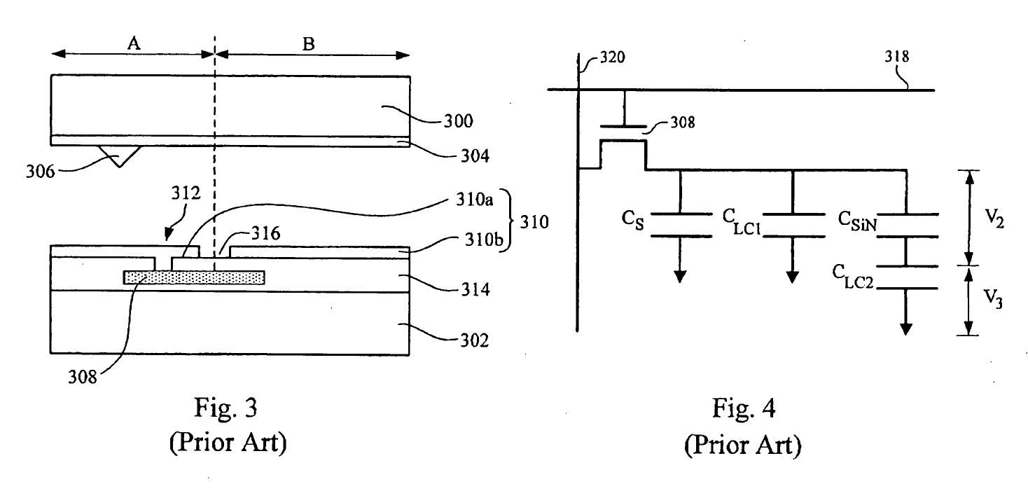

### DETAILED DESCRIPTION OF THE PREFERRED EMBODIMENT

Reference will now be made in detail to the preferred embodiments of the present invention, examples of which are illustrated in the accompanying drawings.

### First Embodiment

The first embodiment of the present invention is to divide a pixel region into two sub-pixel regions. The pixel electrode in each sub-pixel region is connected to a thin film transistor of this sub-pixel region. In other words, no floating state pixel electrode exists in the structure of the present invention. Therefore, the optical characteristic is not affected by the accumulated charge. On the other hand, there is an independent storage capacitor formed in each sub-pixel region. Therefore, by adjusting the capacitance ratio between the two independent storage capacitors, an optimum T-V characteristic may be reached.

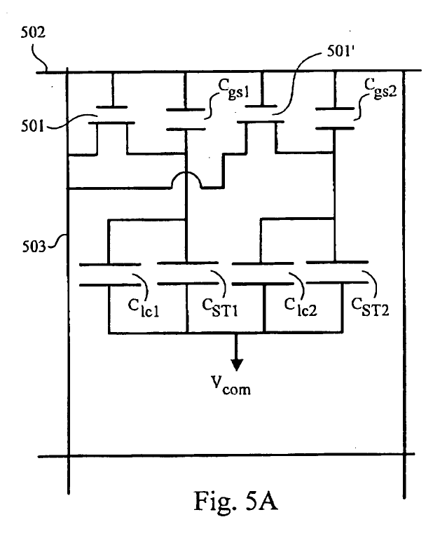

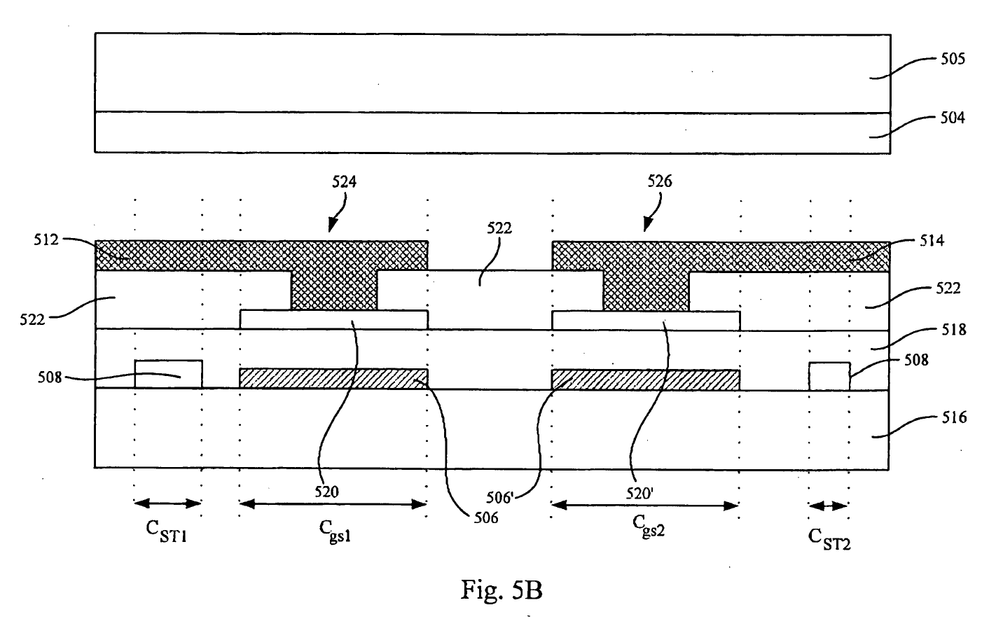

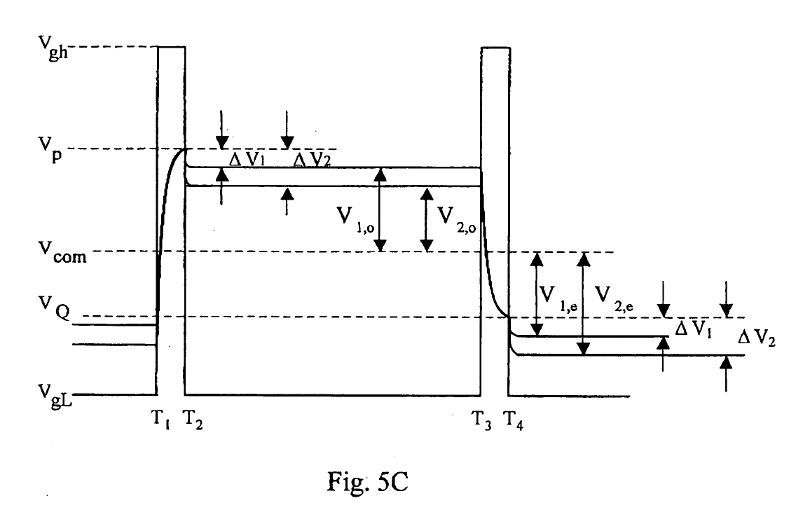

FIG. 5A illustrates a schematic diagram of an equivalent circuit of a pixel region of a liquid crystal display in accordance with the first embodiment of the present invention. The gate electrodes of the switching transistors 501, 501′ are connected with a scan line 502. The drain electrodes of the switching transistors 501, 501′ are connected with a video data line 503. The source electrodes of the switching transistors 501, 501′ are respectively connected to two liquid crystal capacitors C_{LC1} and C_{LC2} and two storage capacitors C_{ST1} and C_{ST2}. The switching transistors 501 and 501′ respectively have diffusion capacitors C_{gs1} and C_{gs 2}.

When the video data line 503 is selected, the drain electrodes of the switching transistors 501, 501′ can receive data from the video data line 503. When the scan signal selects the scan line 502, the switching transistors 501, 501′ are turned on. At this time, the video data transmitted by the video data line 503 can charge the two liquid crystal capacitors C_{LC1} and C_{LC2} and the two storage capacitors C_{ST1} and C_{ST2} through the switching transistors 501, 501′. After the scan signal is removed, the charge is still stored in the two liquid crystal capacitors C_{LC1} and C_{LC2} and the two storage capacitors C_{ST1} and C_{ST2} until the scan signal selects this scan line 502 again. The stored charge in the two liquid crystal capacitors C_{LC1} and C_{LC2} can form an image on the display. The two liquid crystal capacitors C_{LC1} and C_{LC2} in this pixel region together determine the special optical characteristic of this pixel region.

Various pixel structure designs are related to the equivalent circuit shown in the FIG. 5A. FIG. 5B is one of those pixel structures. FIG. 5B illustrates a cross-sectional view of a pixel structure in accordance with the first embodiment of the present invention, in which like numerals represent the same or similar elements. In accordance with the present invention, a common electrode 504 is formed on a glass substrate 505. The gate electrodes 506, 506′ and a storage capacitor electrode 508 of a first metal layer are formed on another glass substrate 516 or other suitable transparent substrate. The storage capacitor electrode 508 may be coupled with the common electrode 504 or coupled with a scan line of an adjacent pixel region. An insulating layer 518 is formed on the substrate 516 to cover the gate electrodes 506, 506′ and the storage capacitor electrode 508. A second metal layer is formed above the insulating layer 518 and the gate electrodes 506, 506′ for forming the source/drain electrodes structure 520, 520′. Moreover, a passivation layer 522 is formed on the top surface of glass substrate 516 to cover the source/drain electrode structures 520, 520′. Two contact holes 524 and 526 are formed on the passivation layer 522 to expose the top surface of the source/drain electrode structures 520, 520′. Then, two separated transparent conductive layers, such as ITO layers 512 and 514 are formed on the passivation layer 522 to respectively connect the source/drain electrode structures 520, 520′.

The diffusion capacitors C_{gs1} and C_{gs2}, are the capacitor between the gate 506, 506′ and source/drain electrode structures 520, 520′. The storage capacitor C_{ST1} is the capacitor between the ITO layer 512 and the storage capacitor electrode 508. The storage capacitor C_{ST2} is the capacitor between the ITO layer 514 and the storage capacitor electrode 508. The liquid crystal capacitor C_{LC1} is the capacitor between the ITO layer 512 and the common electrode 504. The liquid crystal capacitor C_{LC2} is the capacitor between the ITO layer 514 and the common electrode 504. In other words, according to the first embodiment, the pixel region is divided into two sub-pixel regions, in which the first sub-pixel region includes the storage capacitor C_{ST1} and the liquid crystal capacitor C_{LC1}, and the second sub-pixel region includes the storage capacitor C_{ST2} and the liquid crystal capacitor C_{LC2}. In the first embodiment, the capacitances of the liquid crystal capacitors, C_{LC1} and C_{LC2}, of the two sub-pixel regions are the same, and the capacitances of the diffusion capacitors, C_{gs1} and C_{gs2}, are the same as well. However, the capacitances of the storage capacitors, C_{ST1} and C_{ST2} , are different from each other, due to different overlapping areas between the ITO layer 512 and the storage capacitor electrode 508 and between the ITO layer 514 and the storage capacitor electrode 508.

FIG. 5C shows a waveform diagram for driving this pixel structure according to the first embodiment of the present invention. Referring to FIGS. 5A to 5C, in this embodiment, the liquid crystal capacitors C_{LC1} and C_{LC2} are charged to the voltage value, V_{P}, of a positive polarity video data transmitted from the video data line 503 when the scan line 502 simultaneously scans the thin film transistors 501, 501′ at a given time T₁. The thin film transistors 501, 501′ are simultaneously turned off at the non-selective time T₂. The liquid crystal capacitor is maintained by the corresponding storage capacitor. However, the instant the thin film transistors 501, 501′ are turned off, the voltage value (V_{P}) may fall by ΔV. The ΔV is related to the diffusion capacitor C_{gs} between the gate and source electrodes, liquid crystal capacitor C_{LC} and the storage capacitor C_{ST}. Therefore, this pixel region includes two ΔV value, ΔV1 and ΔV2. The ΔV1 value related to the diffusion capacitor C_{gs1}, liquid crystal capacitor C_{LC1} and the storage capacitor C_{ST1} is shown as follows:
ΔV1=(V_{gh}−V_{gi})×C_{gs1}/(C_{gs1}+C_{LC1}+C_{ST1})

The ΔV2 value related to the diffusion capacitor C_{gs2}, liquid crystal capacitor C_{LC2} and the storage capacitor C_{ST2} is shown as follows:
ΔV₂=(V_{gh}−V_{gi})×C_{gs2} /(C_{gs2}+C_{LC2}+C_{ST2})

According to this embodiment, the diffusion capacitor C_{gs1} is equal to the diffusion capacitor C_{gs2}, the liquid crystal capacitor C_{LC1} is equal to the liquid crystal capacitor C_{LC2}, and the capacitance of the storage capacitor C_{ST1} is larger than the capacitance of the storage capacitor C_{ST2}. Therefore, the ΔV2 value is larger than the ΔV1 value.

On the other hand, when the scan line 502 simultaneously scans the thin film transistors 501, 501′ again at a given time T₃, the thin film transistors 501, 501′ are turned on again. The capacitors C_{LC1} and C_{LC2} are charged to the voltage value, V_{Q}, of a negative polarity video data transmitted from the video data line 503. Next, the thin film transistors 501, 501′ are turned off at the non-selective time T₄. The instant the thin film transistors 501, 501′ are turned off, the voltage value (V_{Q}) may fall by ΔV1 and ΔV2, respectively.

Because the storage capacitors C_{ST1} and C_{ST2} differentiate the voltages of the two ITO layers 512 and 514, there are different threshold voltages for transforming the liquid crystal molecule in the two sub-pixel regions. The different threshold voltages present different optical characteristic in the two sub-pixel regions. The optical characteristic of the whole pixel region is determined by combining the optical characteristic of the two sub-pixel regions. An optimum optical characteristic of the whole pixel region is obtained by adjusting the capacitance of the storage capacitors C_{ST1} and C_{ST2}.

The optical characteristic of the two sub-pixel regions can be evaluated by the room mean square voltage of V_{1.0}, V_{1.e} and V_{2.0}, V_{2.e}, respectively, as shown in FIG. 5C.

The room mean square voltage value of the first sub-pixel region is shown as follows:

$$RMS of sub - pixel 1 = \sqrt{\frac{{V}_{1 , 0}^{2} + {V}_{1 , e}^{2}}{2}}$$

The room mean square voltage value of the second sub-pixel region is shown as follows:

$$RMS of sub - pixel 2 = \sqrt{\frac{{V}_{2.0}^{2} + {V}_{2 , e}^{2}}{2}}$$

The voltage value of the V_{1.0} and V_{1.e} are related to the ΔV1 value. The voltage value of the V_{2.0} and V_{2.e} are related to the ΔV2 value. Therefore, the difference between the two RMS voltage values may be adjusted by changing the capacitance of the storage capacitors C_{ST1} and C_{ST2} , respectively. In a preferred embodiment, the difference of the two RMS voltage value is adjusted to about 0.3V.

According to the first embodiment of the present invention, the optical characteristic of the whole pixel region is the combination of the optical characteristic of the two sub-pixel regions. In other words, a user can optimize the optical characteristic of this whole pixel region by adjusting the storage capacitors C_{ST1} and C_{ST2}.

### Second Embodiment

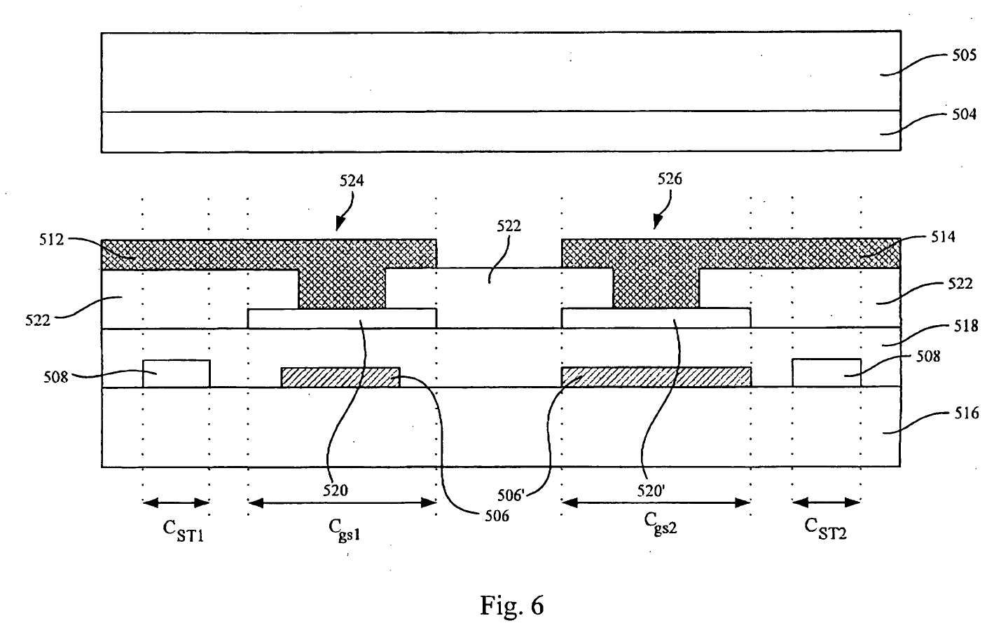

The second embodiment of the present invention is to divide a pixel region into two sub-pixel regions, and the equivalent circuit of the pixel region and the waveform for operating the pixel region is the same as that of the first embodiment. In the second embodiment, the capacitances of the liquid crystal capacitors, C_{LC1} and C_{LC2}, of the two sub-pixel regions are the same, and the capacitances of the storage capacitors, C_{ST1} and C_{ST2}, are the same as well. The feature of the second embodiment is that the diffusion capacitors C_{gs1} and C_{gs2} of two sub-pixel regions have different capacitances. As shown in FIG. 6, an overlapping area between the gate electrode 506′ and the source electrode structure 520′ is larger than that between the gate electrode 506 and the source electrode 520. Therefore, C_{gs2} is greater than C_{gs1}, and ΔV2 is greater than ΔV1. The waveform for operating the pixel region according to the second embodiment is as shown FIG. 5C. Due to the different values of ΔV1 and ΔV2, the optical characteristics of the two sub-pixel regions, evaluated by the room mean square voltage of V_{1.0}, V_{1.e} and V_{2.0}, V_{2.e}, respectively, are different.

According to the second embodiment of the present invention, the optical characteristic of the whole pixel region is the combination of the optical characteristic of the two sub-pixel regions. In other words, a user can optimize the optical characteristic of this whole pixel region by adjusting the diffusion capacitors C_{gs1} and C_{gs2}.

### Third Embodiment

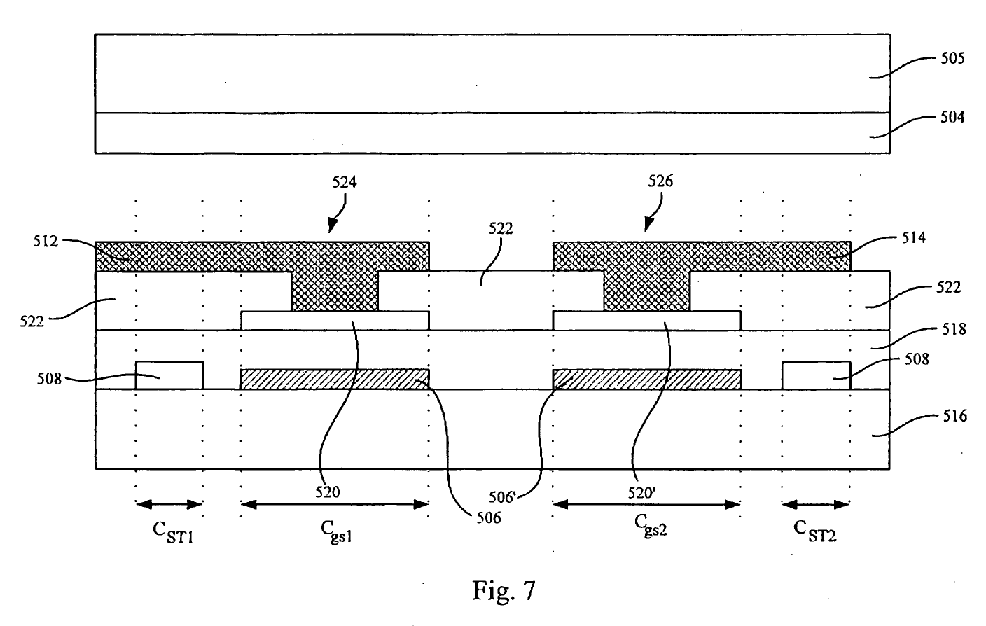

The third embodiment of the present invention is to divide a pixel region into two sub-pixel regions, and the equivalent circuit of the pixel region and the waveform for operating the pixel region is the same as that of the first embodiment. In the third embodiment, the capacitances of the diffusion capacitors, C_{gs1} and C_{gs2}, of the two sub-pixel regions are the same, and the capacitances of the storage capacitors, C_{ST1} and C_{ST2}, are the same as well. The feature of the third embodiment is that the liquid crystal capacitors C_{LC1} and C_{LC2} of two sub-pixel regions have different capacitances. As shown in FIG. 7, an overlapping area between the common electrode 504 and ITO layer 512 is larger than that between the common electrode 504 and the ITO layer 514. Therefore, C_{LC1} is larger than C_{LC2}, and ΔV2 is larger than ΔV1. The waveform for operating the pixel region according to the third embodiment is as shown FIG. 5C. Due to the different values of ΔV1 and ΔV2, the optical characteristics of the two sub-pixel regions, evaluated by the room mean square voltage of V_{1.0}, V_{1.e} and V_{2.0}, V_{2.e}, respectively, are different.

According to the third embodiment of the present invention, the optical characteristic of the whole pixel region is the combination of the optical characteristic of the two sub-pixel regions. In other words, a user can optimize the optical characteristic of this whole pixel region by adjusting the liquid crystal capacitors C_{LC1} and C_{LC2}.

### Fourth Embodiment

The fourth embodiment of the present invention is to divide a pixel region into two sub-pixel regions. The pixel electrode in each sub-pixel region is connected to a thin film transistor of the sub-pixel region. In other words, no floating state pixel electrode exists in the structure of the present invention. Therefore, the optical characteristic is not affected by the accumulated charge. On the other hand, the storage capacitor electrode is connected to a bias voltage. According to the fourth embodiment of the present invention, the capacitances of the storage capacitors are different, so the threshold voltages for transforming the liquid crystal molecule in the two sub-pixel regions will be different. The different threshold voltages will present different optical characteristic in the two sub-pixel regions. The optical characteristic of the whole pixel region is determined by combining the optical characteristic of the two sub-pixel regions. Therefore, by adjusting the capacitance of the two storage capacitors in the sub-pixel regions, an optimum T-V characteristic may be reached.

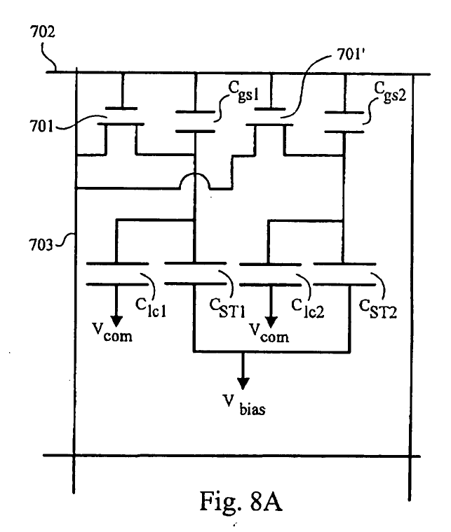

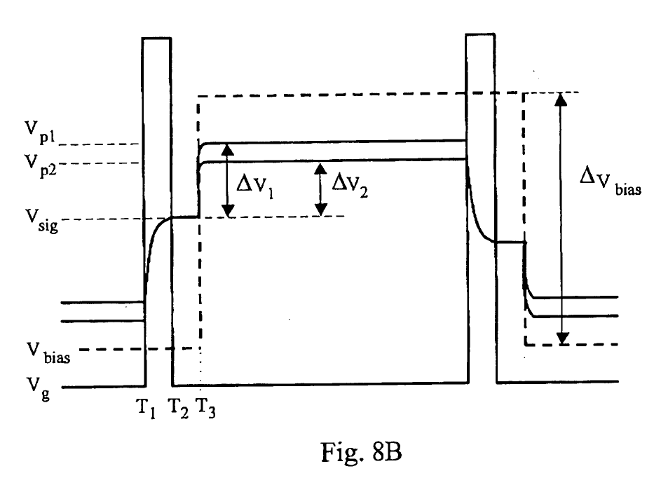

FIG. 8A illustrates a schematic diagram of an equivalent circuit of a pixel region of a liquid crystal display in accordance with the fourth embodiment of the present invention. The gate electrode of the switching transistors 701 and 701′ are connected with a scan line 702. The drain electrode of the switching transistors 701 and 701′ are connected with a video data line 703. The source electrode of the switching transistors 701, 701′ are respectively connected to two separated ITO layers of the two liquid crystal capacitors C_{LC1}, C_{LC2} and the two storage capacitors C_{ST1} , C_{ST2}. Other electrode of the liquid crystal capacitors C_{LC1} and C_{LC2}, i.e. the common electrode, is coupled to the common voltage. Other electrode of the two storage capacitors C_{ST1} and C_{ST2}, i.e. the storage capacitor electrode, is coupled to a bias voltage. The switching transistors 701, 701′ respectively have diffusion capacitors C_{gs1}, C_{gs2}.

The pixel structure is similar to the FIG. 5B. The main difference is that the storage capacitors electrode is coupled to a bias voltage instead of the common voltage.

FIG. 8B shows a waveform diagram for driving this pixel structure according to the fourth embodiment of the present invention. Referring to FIGS. 8A to 8B, in this embodiment, the liquid crystal capacitors C_{LC1} and C_{LC2} are simultaneously charged by the voltage value, V_{sig}, when the scan line scans the thin film transistors 701, 701′ at a given time T₁. The thin film transistors 701, 701′ are turned off at the non-selective time T₂. Next, at time T₃, a bias voltage, V_{bias}, is applied to the storage capacitors C_{ST1} and C_{ST2}. This bias voltage draws up the voltage of the ITO layer connected to the liquid crystal capacitor C_{LC1} of ΔV1 through the storage capacitor C_{ST1} The ΔV1 value related to the diffusion capacitor C_{gs1}, liquid crystal capacitor C_{LC1} and the storage capacitor C_{ST1} is shown as follows:
ΔV1=V_{bias}×C_{ST1}/(_{Cgs1}+C_{LC1}+C_{ST1})

Similarly, this bias voltage, V_{bias}, draws up the voltage of the ITO layer connected to the liquid crystal capacitor C_{LC2} of ΔV2 through the storage capacitor C_{ST2}. The ΔV2 value related to the diffusion capacitor C_{gs2}, liquid crystal capacitor C_{LC2} and the storage capacitor C_{ST2} is shown as follows:
ΔV2=V_{bias}×C_{ST2}/(C_{gs2}+C_{LC2}+C_{ST2})

According to this fourth embodiment, the capacitances of the liquid crystal capacitors, C_{LC1} and C_{LC2}, of the two sub-pixel regions are the same, and the capacitances of the diffusion capacitors, C_{gs1} and C_{gs2}, are the same as well. However, the capacitances of the storage capacitors, C_{ST1} and C_{ST2} , are different from each other, due to different overlapping areas between the pixel electrodes and the storage capacitor electrode. Therefore, the two sub-pixel regions may present different optical characteristic due to the different ΔV value. In other words, there are different threshold voltages for transforming the liquid crystal molecule in the two sub-pixel regions. The optical characteristic of the whole pixel region is determined by combining the optical characteristic of the two sub-pixel regions. Therefore, a user may modify the optical characteristic of sub-pixel regions by adjusting the storage capacitors C_{ST1} and C_{ST2} to reach an optimum optical characteristic of the whole pixel region. It is noted that this operation method also can be used in the second and third embodiments to adjust the diffusion capacitors C_{gs1}, C_{gs2} and the liquid crystal capacitors C_{LC1}, C_{LC2}.

Accordingly, because an optical characteristic of a pixel region is the combination of the optical characteristic of sub-pixel regions, the present invention forms a plurality of sub-pixel regions with adjustable optical characteristic so as to adjust them to form an optimum optical characteristic. According to the foregoing embodiments, a pixel region is divided into a plurality of sub-pixel regions. Each sub-pixel region has independent adjustable parameters related to its optical characteristic. In other words, different optical characteristics may be presented by adjusting the parameter of a sub-pixel region.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A pixel structure of a liquid crystal display, said pixel structure comprising:
a plurality of scan lines arranged in a first direction and parallel to each other; and
a plurality of video data lines arranged in a second direction to cross said plurality of scan lines and parallel to each other, wherein any adjacent scan lines and any adjacent video data lines define a pixel region, each pixel region including at least two sub-pixel regions, and each sub-pixel region comprising:
one switching transistor,which has a gate electrode coupled to said scan line, a source electrode coupled to a tranparent conductive layer, and a drain electrode coupled to said video data line;
wherein said two sub-pixel regions respectively have at least one capacitor, which have different capacitances for differentiating voltages of said two transparent conductive layers.

2. The pixel structure of claim 1, wherein said pixel region further comprises a common electrode, and said two subpixel regions respectively have liquid crystal capacitors with different capacitances formed between said common electrode and said transparent conductive layer.

3. The pixel structure of claim 2, wherein overlapping areas between said common electrode and said transparent conductive layers in siad two subpixel regions are different.

4. The pixel structure of claim 1, wherein said pixel region further comprises a storage electrode and said two sub-pixel regions respectively have storage capacitors with different capacitances formed between said storage electrode and said transparent conductive layer.

5. The pixel structure of claim 4, wherein overlapping areas between said storage electrodes and said transparent conductive layers in said two sub-pixel regions are different.

6. The pixel structure of claim 4, wherein said storage electrode of said pixel region is coupled with a common voltage.

7. The pixel structure of claim 4, wherein said storage electrode of said pixel region is coupled with said scan line of an adjacent pixel region.

8. The pixel structure of claim 4, wherein said storage electrode of said pixel region is coupled with a bias voltage.

9. The pixel structure of claim 1, wherein said two sub-pixle regions respectively have diffusion capacitors with different capacitances formed between said gate electrode and said source electrode of said switching transistor.

10. The pixel structure of claim 9, wherein overlapping areas between said gate electrodes and said source electrodes of said switching transistors in said two sub-pixel regions are different.

11. The pixel structure of claim 1, wherein said transparent conductive layers are indium tin oxide (ITO) layers.
